(19) United States
(12) Patent Application Publication
(10) Pub. No.: US 2026/0357757 A1
(43) Pub. Date: Nov. 12, 2026

(54) FUEL SERVO SYSTEM FOR AN ENGINE

(71) Applicant: Precision Airmotive LLC, Arlington, WA (US)

(72) Inventors: Jeff Sitter, Arlington, WA (US); J. Joshua Christopher, Arlington, WA (US)

(73) Assignee: Precision Airmotive LLC, Arlington, WA (US)

(21) Appl. No.: 19/643,714

(22) Filed: Apr. 9, 2026

Related U.S. Application Data
(60) Provisional application No. 63/786,063, filed on Apr. 9, 2025.

(51) Int. Cl. F02D 9/08; F02M 57/00

(52) U.S. Cl. CPC F02D 9/08; F02M 57/00

(57) ABSTRACT

A fuel injection system includes a venturi slot which Separates a throttle body and air diaphragm located on either side of the venturi slot. The system may also have a suction passageway which allows for air within the throttle body to move to the air diaphragm to measure a venturi throat pressure in the throttle body. The suction passageway and/or the venturi slot may be angled upwardly away from gravity and/or has a portion to act as a dam to keep fuel from exiting the suction passageway and/or the venturi slot. This minimizes fuel to leak out of the venturi slot which would interfere with an air pressure signal measured to the air diaphragm.

### BACKGROUND

Fuel injection systems have replaced carburetors in most modern aircraft engines.

Presently, fuel injection systems provide greater performance, economy, and reliability relative to their carburetor counterparts.

These type fuel injection systems are based on the principle of measuring engine air consumption by use of the venturi tube and using the airflow forces to control fuel flow to the engine. A measure of the airflow consumption of the engine is accomplished by sensing impact pressure (or static pressure) and venturi throat pressure (or suction) in the throttle body. These pressures are vented to the two sides of an air diaphragm. Movement of the throttle valve results in a change in engine air consumption that also changes the velocity of air in the venturi. In short, the movement of the air diaphragm also results in movement of the fuel diaphragm such that fuel is metered to the engine based on airflow. Ordinarily, this setup works quite well; however, issues can occur due to poor piloting procedures. The two issues primarily occurs in updraft servo configurations when pilots, often student pilots, do not shut off fuel to the fuel system after the engine is shut down and repeatedly over-prime during engine startup such that excess fuel accumulates and runs down into the fuel servo. Over time, this accumulation of fuel can puddle within the venturi and flow into the suction ports therein.

### SUMMARY

Aspects to at least some embodiments of the present application relate to systems for a system for fuel servos that will mitigate or eliminate possible negative side effects of poor piloting procedures, namely over-priming during engine startup.

The objective of some embodiments is to provide a “dam” to prevent accumulated fuel from migrating beyond the venturi into the airflow communication passages within the throttle body. One embodiment to this solution is changing the orientation of the suction cutout in the venturi from a horizontal cut to one that enters the body at an approximate upward angle.

One embodiment is directed to a fuel injection system. The fuel injection system may include a venturi tube which separates a throttle body an air diaphragm located on either side of the venturi tube. The fuel injection system may also include a suction passageway that connects the venturi tube to the air diaphragm and is angled upwardly away from gravity so as to act as a dam to keep fuel from exiting a the venturi tube which would interfere with an air pressure signal measured to the air diaphragm.

According to another embodiment, a fuel injection system may include a venturi tube which separates a throttle body an air diaphragm located on either side of the venturi tube; and a suction cutout which allows for air within the throttle body to move to the air diaphragm to measure a venturi throat pressure in the throttle body. The suction cutout is orientated so that fluid is prevented from freely flowing from the section cutout into an airflow communication passage within a throttle body.

In yet another embodiment, a method of operating a fuel injection system is provided that may include: (1) providing fuel to a throttle body, where the fuel travels to a venturi tube which separates the throttle body and an air diaphragm located on either side of the venturi tube; and (2) holding the fuel in using a suction passageway that is in between the venturi tube and the air diaphragm and is angled upwardly away from gravity so as to act as a dam to keep fuel from exiting the venturi tube which would interfere with an air pressure signal measured to the air diaphragm.

Other embodiments can include a secondary sleeve (metallic or elastomeric) that is installed or otherwise joined to the outer diameter of the venturi to accomplish the same purpose

The skilled person will appreciate that except where mutually exclusive, a feature described in relation to any one of the above embodiments may be applied mutatis mutandis to any other embodiment.

### BRIEF DESCRIPTION OF THE DRAWINGS

The disclosure will be described with reference to the accompanying drawings, wherein like numbers reference like elements.

FIG. 1 is a schematic cross-sectional view of a fuel injection system, according to one embodiment.

FIG. 2 is a throttle body fuel injection servo, according to one embodiment.

FIG. 3 is crossectional views of a throttle body fuel injection servo showing the horizontal suction cutouts, according to one embodiment.

FIGS. 4 and 5 are crossectional views of a throttle body fuel injection servo showing the upwardly angled suction cutouts, according to one embodiment.

FIGS. 6A, 6B, AND 6C are different crossectional views of a throttle body fuel injection servo showing the horizontal suction cutouts, according to one embodiment.

FIG. 7 is a crossectional view of a throttle body fuel injection servo showing the suction cutout being a step up relative to the slot, according to one embodiment.

FIG. 8 is a crossectional view of a throttle body fuel injection servo showing the suction cutout having an elevation increase, according to one embodiment.

FIG. 8 illustrates a cross-sectional view of a throttle body injection servo showing the suction passageway angled up and back down starting at the edge of the slot, according to one embodiment.

FIG. 9 is a perspective view of a throttle body fuel injection servo having a band that goes around the fuel injection body to serve as a dam at the edge of the slot, according to one embodiment.

FIG. 10 is a cross-sectional view of a throttle body fuel injection servo of FIG. 9 with a band forcing fuel to dam at the edge of the slot, according to one embodiment.

FIG. 11 illustrates a cross-sectional view of a throttle body fuel injection servo showing the suction cutout extending vertically to create a damn and the suction passageway positioned at the top of the suction cutout, according to one embodiment.

FIG. 12 illustrates a cross-sectional view of a throttle body fuel injection servo showing the suction passageway angled up starting at the suction cutout so fuel will not exit the suction cutout or passageway, according to one embodiment.

### DESCRIPTION OF EXEMPLARY EMBODIMENTS

As mentioned above, the present disclosure discloses fuel servo engine that will mitigate or eliminate possible negative side effects of poor piloting procedures. More details are provided below.

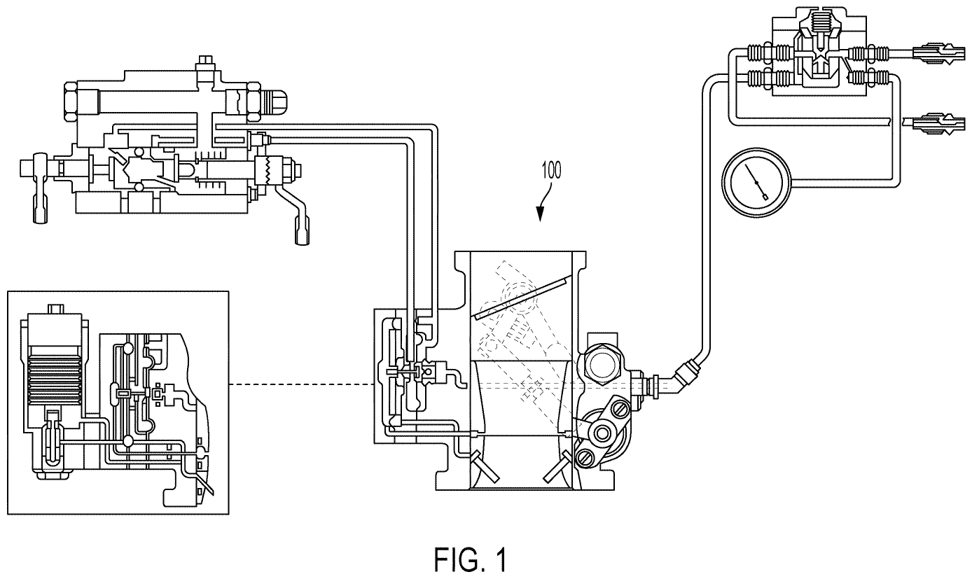

Fuel injection systems used in aircraft engines are volume-air flow type systems, which are based on the principle of measuring air flow to establish correct fuel flow to the engine cylinders. As shown in FIG. 1, these systems include a throttle body fuel injection servo which measures the amount of air moving past the throttle by use of a venturi. An in-line diaphragm type flow regulator then converts the air pressure from the venturi into a proportional fuel pressure.

FIG. 1 is a schematic cross-sectional view of a fuel injection system, according to one embodiment. In the top-left of FIG. 1, a valve assembly is shown that includes a mixture control valve and idle control valve. The fuel injection system includes a fuel inlet to accept fuel from, for example, a fuel pump (not shown) before directing such fuel through the fuel strainer and into the cavity housing the mixture control valve and idle control valve. The mixture control valve is connected to the manual mixture control lever. A throttle valve is connected to the idle valve lever. Within the valve assembly cavity housing is also a metering jet for the delivery of fuel, whereby the idle control valve regulates the metered fuel pressure (shown in dark pink) and the mixture control valve regulates the unmetered (inlet) fuel pressure (shown in red), each to separate sides of a fuel diaphragm housed within the fuel regulator of the servo system.

The valve assembly (i.e., fuel pressure modifying mechanism) receives fuel from a fuel supply and delivers the fuel at a pressure that is different from the fuel supply to the fuel regulator assembly. Some of the major components of valve assembly include an idle valve assembly and a mixture valve assembly. The mixture valve assembly as shown in FIG. 1 includes a mixture valve connected to the mixture control lever.

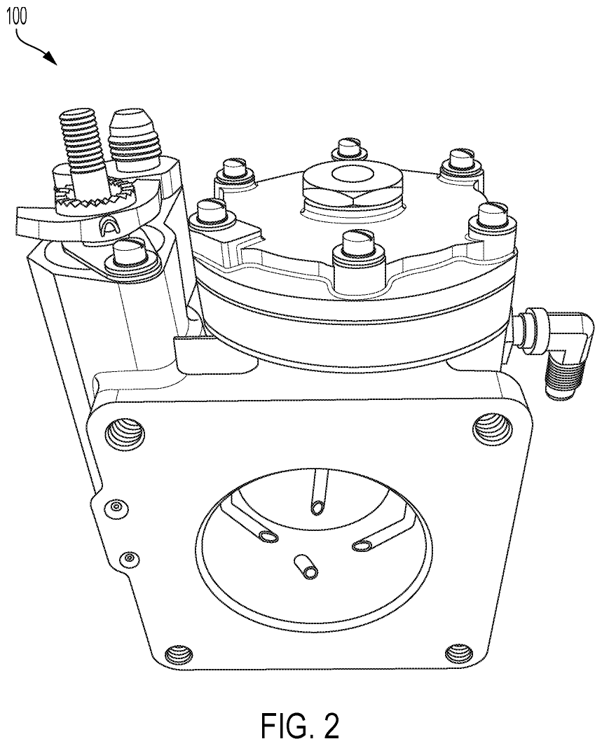

During normal operation of the aircraft engine, the position of the throttle controls the air flow through the fuel injection servo or to the regulator, which then controls the flow of fuel to the cylinders. The servo (FIG. 2) is the primary component used in the fuel injection system and performs all functions required to establish fuel flow volumes. The regulated fuel flow from the servo is sent to a fuel flow divider, which divides the steady stream of fuel into smaller streams of fuel, one for each cylinder. Fuel lines carry fuel from the divider to injector nozzles located in the intake ports of each cylinder. The injectors supply fuel to the intake manifold. Fuel then enters the cylinders from the intake manifold under the low pressure created in the cylinder during the intake cycle.

During normal operation of the aircraft engine, the position of the throttle and the air flowing through the fuel injection servo or flow regulator controls the flow of fuel to the cylinders of the aircraft engine. As the throttle is opened, more fuel is delivered to each cylinder, resulting in an increase in the speed of the engine or in manifold pressure, and thus more power being generated by the engine. Generally, most fuel injection servos include an air passage mechanism (i.e., the throttle body), a fuel pressure modifying mechanism (i.e., the valve assembly), and a fuel regulator assembly.

### Horizontal Suction Cutout

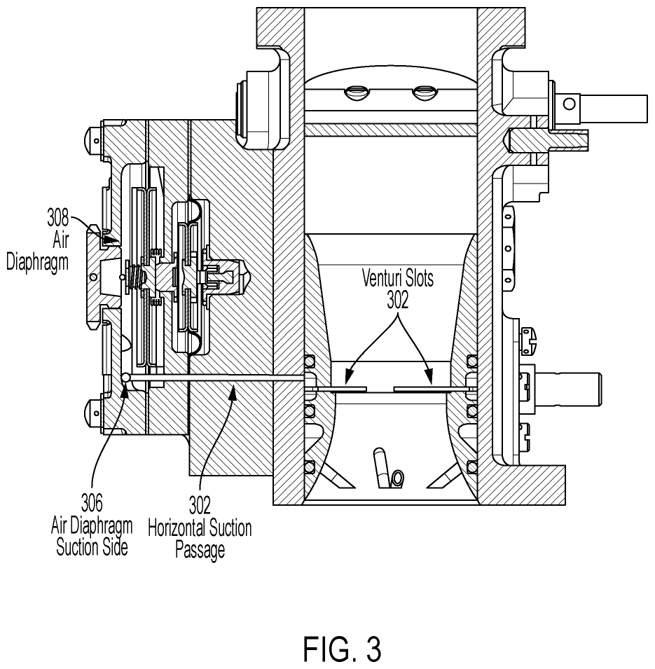

As shown in FIG. 3, the venturi has suction passage 304 and venturi slots 302 which are horizontal (or generally perpendicular relative to gravity). As mentioned above, issues can occur with these horizontal venturi slots end 302 at the suction passage allowing fluid (e.g., fuel) to flow out of the suction passage 304 without any forces limiting the movement of the fluid. The issues may be due to overpriming or other improper operation of the engines. For example, repeatedly over-priming during engine startup can result in excess fuel accumulating and running down into the fuel servo, in which, over time, this accumulation of fuel can puddle within the venturi slot 302 and flow into the suction passage therein.

The horizontal nature of the suction passage 304 relative to the venturi slot 302 allows for the fuel to freely travel through the suction passage 304 without any resistance or blockage.

### Angled Suction Slot

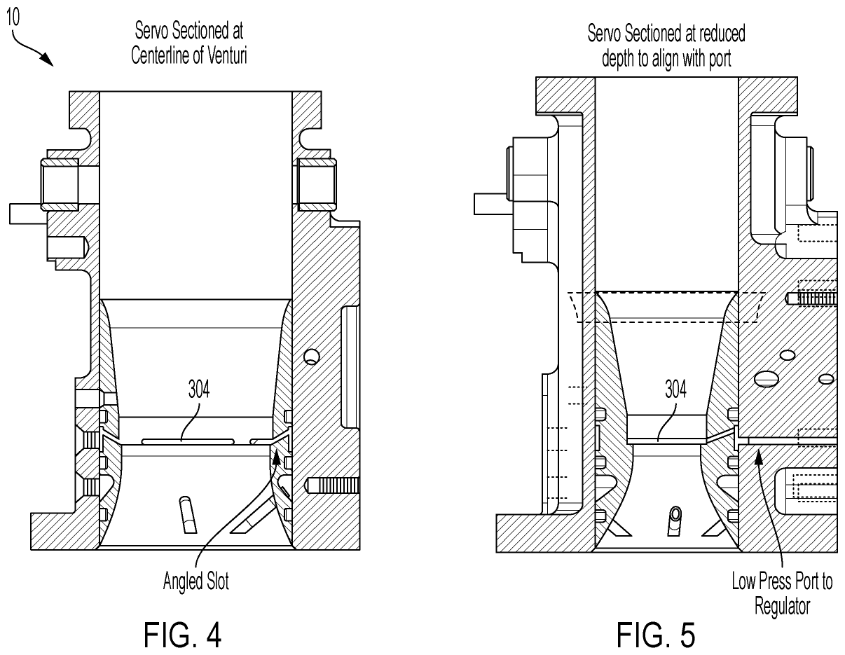

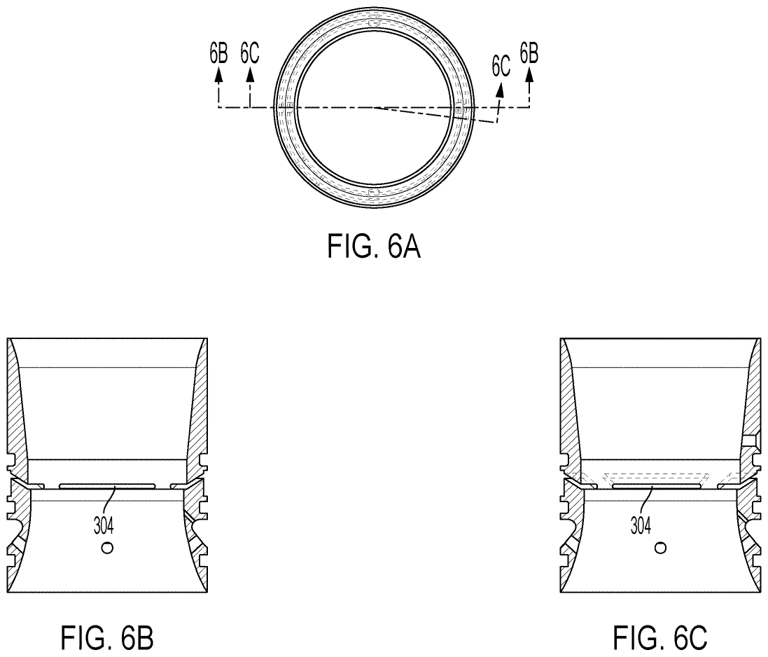

Accordingly, an objective of embodiments of the invention is to provide a “dam” or forces against the accumulated fuel to prevent the accumulated fuel from migrating beyond the venturi into the airflow communication passages within the throttle body. As shown in FIGS. 4, 5 and 6, one embodiment to this solution is changing the orientation of the venturi slot 302 (the section cutout in the venturi) from a horizontal cut to one that enters the body at an approximate upward angle (an angle such that the slot proceeds away from the direction of gravity), such as at a 15° angle, a 20° angle, a 25° angle, a 30° angle, a 35° angle, a 40° angle, or the like.

This makes it so that fuel that does accumulate in the venturi slot 302 will have to travel against gravity to exit the slot and thus, cannot freely exit the venturi as opposed to the embodiment shown in FIG. 3. This is because the venturi slot 302 being angled at an upward angle relative to the ground creates a dam to keep the fuel from exiting the suction cutouts.

It should be understood that there are other embodiments within the scope of the present application.

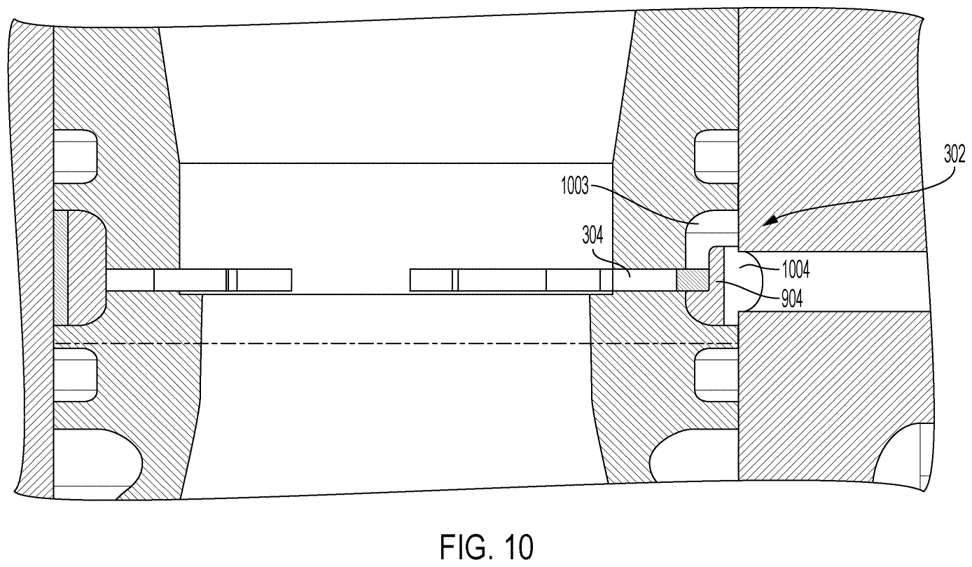

Other embodiments can include a secondary sleeve (metallic or elastomeric) that is installed or otherwise joined to the outer diameter of the venturi to accomplish the same purpose. For example, as shown in FIG. 10, the sleeve may be such to hold or prevent accumulated fuel from migrating beyond the venturi into the airflow communication passages within the throttle body. In this regard, air would flow normally through the system but the sleeve is used to hold excess fuel so that the fuel does not interfere with the airflow communication passages in the throttle body. This embodiment is discussed more later herein with regard to FIG. 10.

Various other embodiments are also possible including a holding reservoir, a redirection means to redirect fuel away from the communication passages, or the like to accomplish the above stated purposes.

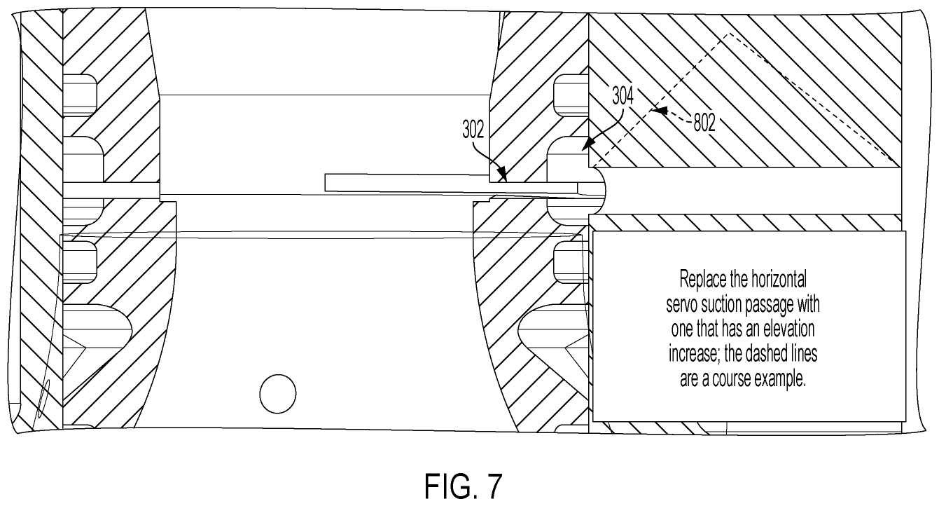

Accordingly, some of the other embodiments are shown in FIGS. 7-10.

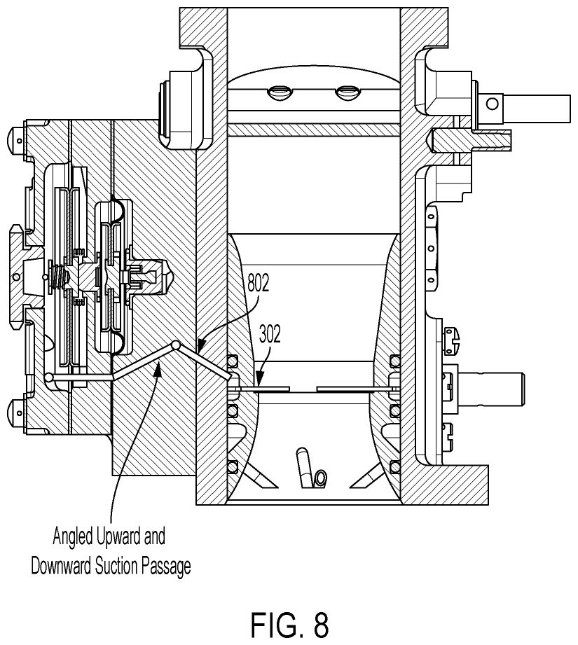

First, FIGS. 7 and 8 each is a crossectional view of a throttle body fuel injection servo showing a first suction cutout 304 leading to a second section passage 802 having an elevation increase relative to the first section passage 304, according to one embodiment. FIG. 7 shows the typical venturi slot and the suction passage but the dotted line shows how this suction passage can be replaced from a horizontal suction passage where fuel can easily flow from the venturi slot especially if movement or sloshing occurs, to a suction passage where the fuel cannot flow easily from the exit of the venturi slot.

Indeed, FIG. 8 shows this replacement of the suction passage. As shown in FIG. 8, the first suction passage 304 is in line with the venturi slot 302 but the second suction passage 802 then travels diagonally away from the forces of gravity while also traveling away from the venturi slot 302. In this regard, in order for fluid to flow from the venturi slot 304 to the second suction passage 802, the fluid must immediately and directly flow against the forces of gravity starting at the end of the venturi slot. The direction from this end of the venturi slow thus is orthogonally upwards so that the suction passage 802 is above the slot 302 relative to the force of gravity. In this regard, in order for any fluid to travel from the venturi slot 302 to the second suction passage 802, the fluid must travel against the forces of gravity.

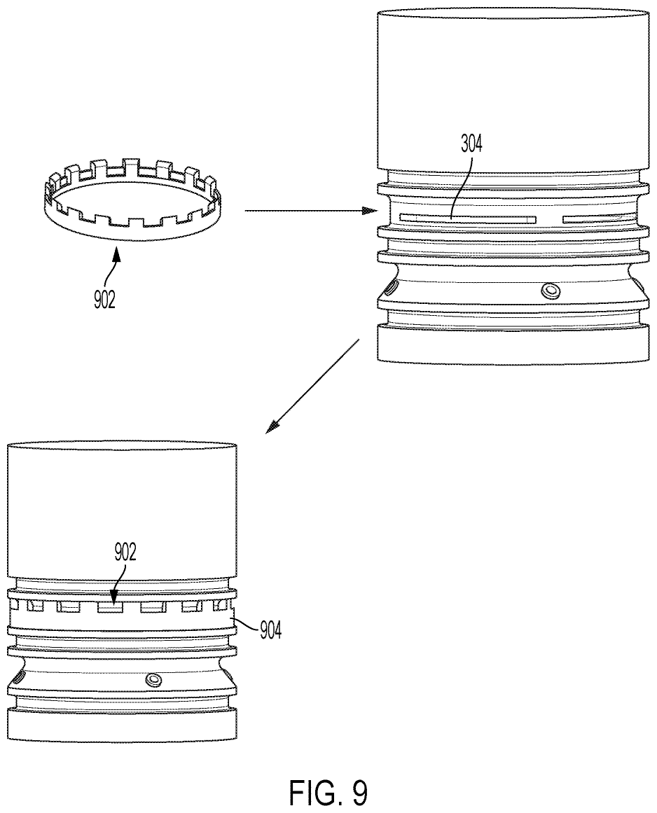

FIG. 9 is a perspective view of a throttle body fuel injection servo having a band 902 that goes around the fuel injection body to serve as a damn at the edge of the slot 304, according to one embodiment. As shown, the band 902 may be a rubber or otherwise elastic so that the band 902 is able to create a blockage 904 so that fluid from the venturi slot 304 and then up against gravity through a first portion 1003 of the section cutout 302 when the fluid can then flow down to a second portion 1004 of the section cutout 302, as shown in FIG. 10. FIG. 10 is a stand servo (with a horizontal suction passage) with venturi with band installs which creates a dam.

In light of the above, various embodiments include systems so that fluid in the Venturi slot have to travel against gravity or is stopped from flowing (e.g., via FIG. 10) so that the fluid does not freely flow out of the Venturi slot without some resistance or force provided thereagainst. In this way, some embodiments provide a “dam” to prevent accumulated fuel from migrating beyond the venturi into the airflow communication passages within the throttle body, which will mitigate or eliminate possible negative side effects of poor piloting procedures, namely over-priming during engine startup.

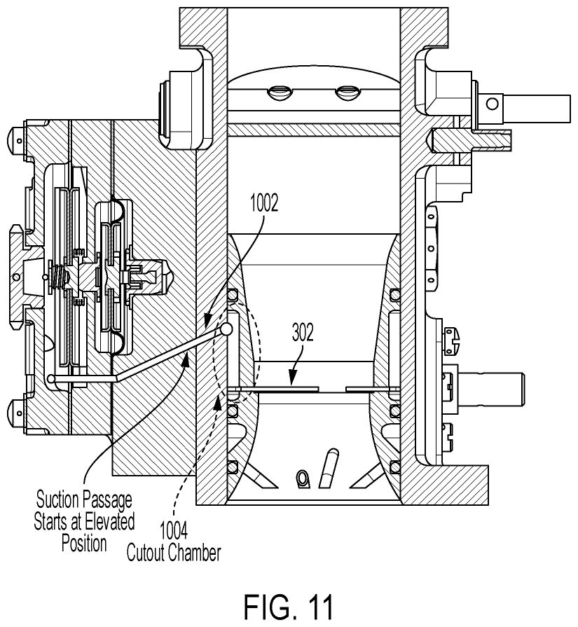

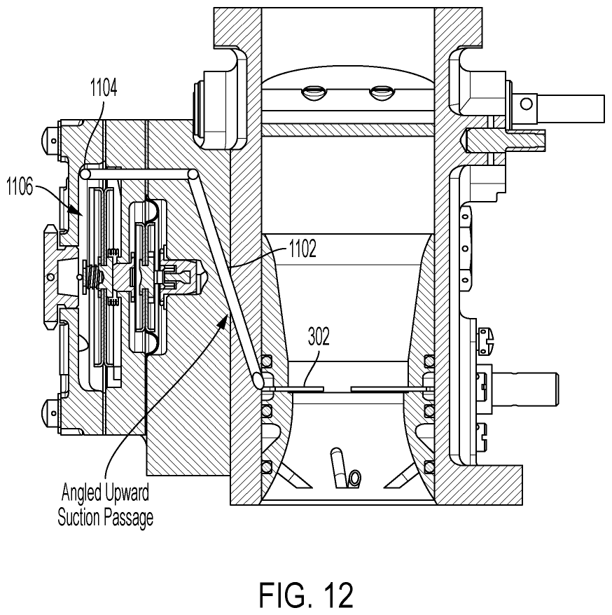

FIGS. 11 and 12 are additional embodiments showing a servo with a suction passage starting at an end of an elongated chamber (e.g., chamber 1004). Referring first to FIG. 11, FIG. 11 is a crossectional view of a throttle body fuel injection servo showing the venturi slot 302 leading to a cutout chamber 1004 which extends vertically opposite of the force of gravity to a suction passage 1002. The cutout chamber 1004 has an elevation increase relative to a venturi slot 1002, according to one embodiment, so that the cutout chamber 1004 is such that any fuel leaving the venturi slot 302 will have to travel vertically away from the forces of gravity to leave the venturi slot 302. In this regard, in order for fluid to flow from the venturi slot 302 to the suction passage 1002, the fluid must flow against the forces of gravity via the cutout chamber 1004. The direction thus is orthogonally upwards so that the beginning of the suction passage 1002 is above the venturi slot 302 relative to the force of gravity. In this regard, in order for any fluid to travel from the venturi slot 302 to get to the suction passage 1002, the fluid must travel against the forces of gravity.

FIG. 12 is a crossectional view of a throttle body fuel injection servo showing the venturi slot 302 leading to a suction passage 1102 having an elevation increase relative to a section cutout 1004, according to one embodiment. The suction cutout 1004 is at an angle with the venturi slot 302 where the angle is such that the suction passage 1002 then travels diagonally and/or vertically away from the forces of gravity while traveling away from the venturi slot 302. In this regard, in order for fluid to flow from the venturi slot 302 through the suction cutout 1002, the fluid must flow against the forces of gravity. The direction thus is at least partially orthogonally upwards so that the suction passage 1002 is above the slot 302 relative to the force of gravity. In this regard, in order for any fluid to travel from the venturi slot 302 to the suction passage 1002, the fluid must travel against the forces of gravity.

It should be noted that in FIG. 12, the exit of the suction passage 1104 is at the top of the air diaphragm 1106. This allows for the suction passage 1104 to have a higher angle that is close to exactly opposite to the force of gravity and to create a longer path in this angled pathway away from gravity, as compared to the suction passage in FIG. 11 which has an end that is connected to the bottom of the air diaphragm 1106.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “has,” “ have,” “having,” “includes,” “including,” “comprises” and/or “comprising,” when used in this specification, specify the presence of stated features, integers, steps, operations, elements, and/or components, but do not preclude the presence or addition of one or more Other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The explicit description of the present invention has been presented for purposes of illustration and description, but is not intended to be exhaustive or limited to embodiments of the invention in the form explicitly disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A fuel injection the fuel injection system comprising:
a venturi slot which separates a throttle body an air diaphragm located on either side of the venturi slot; and
a suction passageway that connects the venturi slot to the air diaphragm and is angled upwardly away from gravity so as to act as a dam to keep fuel from exiting the venturi slot which would interfere with an air pressure signal measured to the air diaphragm.

2. The fuel injection system of o claim 1, further comprising: a suction passageway which allows for air within the throttle body to move to the air diaphragm to measure a venturi throat pressure in the throttle body.

3. The fuel injection system of claim 2, wherein the section passage is part of the venturi slot.

4. The fuel injection system of claim 3, wherein the section cutout is connected to the end of the venturi slot and extends vertically in a direction that is opposite of the force of gravity relative to the end of the venturi slot.

5. The fuel injection system of claim 2, wherein one end of the suction passageway connects with the air diaphragm and another end of the suction passageway connects with the section cutout.

6. The fuel injection system of claim 1, wherein one end of the suction passageway connects with the air diaphragm and another end of the suction passageway connects with the venturi slot.

7. The fuel injection system of claim 6, wherein the end of the suction passageway that connects with the air diaphragm connects with an uppermost portion of the air diaphragm that is above a centerline of the air diaphragm.

8. The fuel injection system of claim 6, wherein the end of the suction passageway that connects with the air diaphragm with a lower most portion of the air diaphragm that is below a centerline of the air diaphragm.

9. A fuel injection system, the fuel injection system comprising:
a venturi slot which separates a throttle body an air diaphragm located on either side of the venturi slot;
a first suction passageway which allows for air within the throttle body to move to the air diaphragm to measure a venturi throat pressure in the throttle body, and
wherein the first suction passageway is orientated so that fluid is prevented from freely flowing from the first section passageway into an airflow communication passage within a throttle body.

10. The fuel injection system of claim 9, further comprising:
a second suction passageway that connects the first suction passageway to the air diaphragm while the first suction passageway acts as a dam to keep fuel from exiting a the venturi slot which would interfere with an air pressure signal measured to the air diaphragm and the second suction passageway then removes such fluid.

11. The fuel injection system of claim 10, wherein a first end of the second suction passageway connects the first suction passageway and is angled downwardly towards gravity and towards the air diaphragm.

12. The fuel injection system of claim 9, wherein the first section passageway is part of the venturi slot.

13. A method of operating a fuel injection system, the method comprising:
providing fuel to a throttle body, where the fuel travels to a venturi slot which separates the throttle body and an air diaphragm located on either side of the venturi slot; and
holding the fuel in using a suction passageway that is in between the venturi slot and the air diaphragm and is angled upwardly away from gravity so as to act as a dam to keep fuel from exiting the venturi slot which would interfere with an air pressure signal measured to the air diaphragm.

14. The method of claim 13, wherein the suction passageway includes a section cutout that is vertically extending from an end of the venturi slot so that the section cutout acts as a dam to hold the fuel exiting the venturi slot.
